(19) United States
(12) Patent Application Publication
(10) Pub. No.: US 2006/0171315 A1
(43) Pub. Date: Aug. 3, 2006

(54) Resource allocation device for providing a differentiated service and a method thereof

(76) Inventors: Da-Hye Choi, Boryeong-city (KR); Hyun-Joo Kang, Andong-city (KR); You-Hyeon Jeong, Seoul (KR); Tae-Man Han, Daejeon-city (KR); Byeong-Sik Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/223,714

(22) Filed: Sep. 8, 2005

(30) Foreign Application Priority Data
Nov. 23, 2004 (KR) 10-2004-0096375

(51) Int. Cl. H04L 12/26

(52) U.S. Cl. 370/230; 370/395.2

(57) ABSTRACT

A resource allocation device includes a database of user and service information, a resource allocation management unit for determining whether a service request agrees with a service level agreement and whether it accepts a resource allocation request, a service level agreement unit for negotiating the service level agreement with the user, sending the received service request to the resource allocation management unit, acquiring the result of the resource allocation request, and transmitting the result of the resource allocation request to the user, a routing information management unit for obtaining a network configuring information, storing the network configuring information in the database, discovering the path to provide the service and storing the discovered path in the database to be reused and a policy control management unit for deciding a policy according to whether the service request and the resource allocation request are accepted.

### CROSS-REFERENCE TO RELATED APPLICATION

This application claims priority to and the benefit of Korean Patent Application 10-2004-0096375 filed in the Korean Intellectual Property Office on Nov. 23, 2004, the entire content of which is incorporated herein by reference.

### BACKGROUND OF THE INVENTION

(a) Field of the Invention

The present invention relates generally to a resource allocation device for providing a differentiated service and a method thereof. More particularly, the present invention relates to a resource allocation device and a method thereof using a path storage device wherein the path connects a border router of a domain including a source with a border router of a domain including a destination.

(b) Description of the Related Art

Recently, in Internet services, expectations about Quality of Service (QoS), such as large bandwidth and low delay, have become higher than ever. Particularly, since Internet services are based on the Internet Protocol (IP), more reliable, guaranteed QoS than that of the Internet should be supported. However, there is no way to guarantee that packets will be reliably delivered to the destination in the current Internet system. Therefore, various solutions have been provided to guarantee a high quality of service.

Particularly, an Integrated Service (Intserv) using a Resource Reservation Protocol (RSVP) has been provided. The Intserv has problems in several aspects. In detail, reserving resources per-flow introduces severe scalability and information maintenance problems, and supporting RSVP protocol in the current application programs introduces severe scalability and compatibility problems. More recently, a Differentiated Service (DiffServ) has been developed to provide differentiated services instead of a Simple Best Effort Service, and simultaneously to solve the scalability and compatibility problems.

The DiffServ is designed to improve an IPv4 priority marking service defined by RFC 791 and to provide various services on the Internet. The DiffServ is implemented by means of predefining a service aggregation having an end to end priority, defined as Per-Hop Behavior (PHB). Thus, it is unnecessary to maintain an information regarding service. Also, it can be realized with only a small amendment of the current network.

Korean Application No. 1999-55830, filed on Dec. 8, 1999, entitled “connection admission control method and apparatus using status of routers in differentiated service network” is incorporated herein by reference.

This prior art discloses a connection admission control device and method using status of routers in a differentiated service IP network so as to provide a reliable, QoS guaranteed service to a user. This device and method uses status of a core router, which is installed in the path through which the user data is really passing, as well as status of an edge router and a service level agreement (SLA) to implement a connection admission control processing. Therefore, the connection admission control processing may be performed reliably so as to provide a QoS guaranteed service.

Also, Korean Application No. 2003-13509, filed on Mar. 4, 2003, entitled “Apparatus for allocation resources based on path color for providing differentiated service and method thereof” is incorporated herein by reference. In detail, this device and method uses a resource allocation device and method based on a path color to provide a differentiated service. Therefore, the user can be provided with a priority service according to a request and the current standard differentiated service can be commercialized.

Meanwhile, in order to guarantee QoS of the differentiated service model, it is necessary to provide a device for managing/monitoring network resources, catching the specified resource corresponding to the user request, and deciding accept/reject. Such a device is called a Bandwidth Broker.

Logically, it appeared that only one bandwidth broker exists in one domain. But, physically, one bandwidth broker may include various secondary devices.

For example, when the user requests a bandwidth broker to use a resource, the bandwidth broker decides to accept/reject a request, considering general flow information. When the request is accepted, the border router marks a Differentiated Service Code Point (DSCP) matching with the PHB on a packet of the user.

At this time, a Resource Allocation Request (RAR) indicates a desired amount of resource and an available reservation period. To handle these requests of the user, the bandwidth broker stores various Service Level Agreements (SLA) and the bandwidths allocated per SLA, in a database as the basic information for later deciding an allocation amount. The bandwidth broker allocates the priority service based on the basic information to the user in response to the request, and functions to configure a communication network router such that the predefined service is correctly delivered. Also, the bandwidth broker communication is classified into two types, a domain to domain communication and a communication in domain. The communication in domain may be desired to be standardized, since the domain can use different installations and mechanisms. The communication in domain may be desired to decide whether RAR is accepted, especially on using an external policy server. However, the bandwidth broker communication has been concentrated on the PHB setting, since the communication in domain is not standardized and also most of the router manufacturers have been using respective methods to set the router.

For example, a Simple Network management Protocol (SNMP), a Management Information Base (MIB), a Common Open Policy Service (COPS), and a Policy Information Base (PIB) are disclosed by a differentiated service working group of an Internet Engineering Task Force (IETF). The MIB and PIB have both been standardized in the form of an Internet draft (Draft).

However, because these bandwidth broker software should manage a network irregardless of the type of routers, they can be installed in different type of routers, as well as MIB or PIB, to support a differentiated service.

Also, because the bandwidth broker can control only resources in domain, it has a drawback that it cannot set routers of other domains. Therefore, pre-negotiated SLA are demanded between the adjacent domains For example, with the pre-negotiated SLA, the bandwidth broker accepts a bandwidth allocation request for the adjacent domains, and appoints a specified class to allocate a bandwidth. Thereafter, the bandwidth broker sets border routers of an inter-domain and cooperates with the adjacent domains regarding a bandwidth reservation.

According to these prior arts, since only a resource allocation device is used to provide a differentiated service, it is not easy to perform a fast path information discovery processing and it cannot provide a differentiated service efficiently.

The above information disclosed in this Background section is only for enhancement of understanding of the background of the invention and therefore, it should be understood that the above information may contain information that does not form the prior art that is already known in this country to a person or ordinary skill in the art.

### SUMMARY OF THE INVENTION

The present invention has been made in an effort to provide a resource allocation device and a method thereof having advantages of performing fast path information retrieval and providing differentiated services efficiently.

An exemplary resource allocation device according to an embodiment of the present invention includes a database, a resource allocation management unit, a service level agreement unit, a routing information management unit, and a policy control management unit.

The database concerns user and service information.

The resource allocation management unit is for determining whether a service request agrees with a service level agreement and whether it accepts/rejects a resource allocation request using available resource information of a path connecting a beginning point with an end point, on receiving the service request of a user.

The service level agreement unit is for negotiating the service level agreement with the user before receiving the service request, sending the received service request to the resource allocation management unit, acquiring the result of the resource allocation request and transmitting the result of the resource allocation request to the user.

The routing information management unit is for obtaining a network configuring information, storing the network configuring information in the database, discovering the path to provide the service, and storing the discovered path in the database to be reused.

The policy control management unit is for deciding a policy according to whether the service request and the resource allocation request are accepted.

In a further embodiment, a resource allocation method for providing differentiated service includes the following steps: receiving a service request from a user, determining whether a resource can be allocated to provide the requested service, obtaining routing information from routers composing a differentiated service, searching, discovering, and storing path information using the obtained routing information, transmitting a determined policy to real routers; and allocating a resource according to the determined policy.

According to an exemplary embodiment of the present invention, it is determined that the service request can be supported and the result of the service request allows a resource to really allocate so that the differentiated service can be provided efficiently. Also, in the path information acquisition processing, the path information search can be quickly implemented by using the storage device so that the developed commercialization model of the differentiated service can be applied.

### BRIEF DESCRIPTION OF THE DRAWINGS

FIG. 1 is a general schematic diagram of a network capable of providing differentiated services.

FIG. 2 is a schematic diagram of a network capable of providing a differentiated service according to an exemplary embodiment of the present invention, wherein a bandwidth broker is used as a resource allocation device.

FIG. 3 is a schematic diagram of a bandwidth broker used as a resource allocation device according to an exemplary embodiment of the present invention.

FIG. 4A to FIG. 4C respectively are a flowchart illustrating a resource allocation processing according to an exemplary embodiment of the present invention.

FIG. 5 is a flowchart illustrating a service level agreement processing for allocating a resource according to an exemplary embodiment of the present invention.

FIG. 6 is a detailed flowchart illustrating the service request processing of FIG. 5.

FIG. 7 is a detailed flowchart illustrating a path discovery processing among the service request processing of FIG. 6.

### DETAILED DESCRIPTION OF THE EMBODIMENTS

An embodiment of the present invention will hereinafter be described in detail with reference to the accompanying drawings.

In the following detailed description, only the preferred embodiment of the invention has been shown and described, simply by way of illustration of the best mode contemplated by the inventor(s) of carrying out the invention. As will be known, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

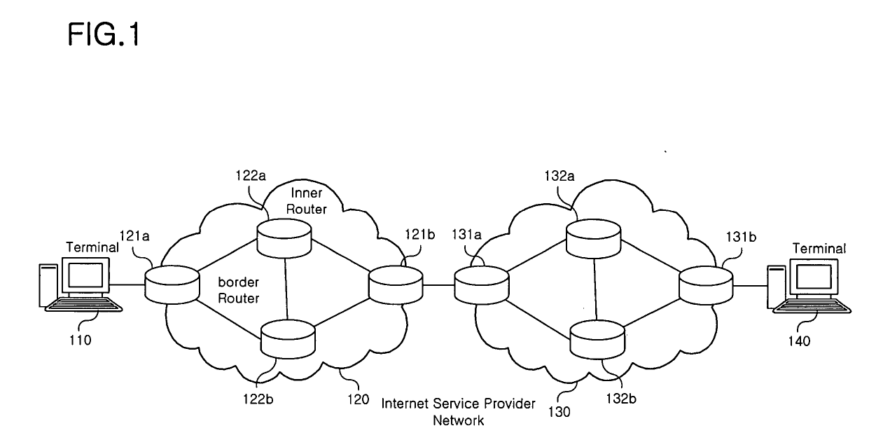

FIG. 1 is a general schematic diagram of a network capable of providing a differentiated service. Referring to FIG.1, terminal devices 110 and 140, and Internet service provider networks 120 and 130 are illustrated. The Internet service provider networks 120 and 130 include border routers 121a, 121b, 131a, and 131b, and inner routers 122a, 122b, 132a, and 132b.

The terminal devices 110 and 140 are provided at ends of the network and may be, for example, a user terminal, a client, or a server. The terminal devices 110 and 140 perform a communication so as to apply a differentiated service and the Internet service provider networks 120 and 130 provide a requested service to the terminal devices 110 and 140.

The border routers 121a and 121b are provided in the first Internet service provider network 120 and are coupled with the second Internet service network 130, as well as with the terminal device 110.

Likewise, the border routers 131a and 131b are provided in the second Internet service provider network 130 and are coupled with the first Internet service network 120, as well as with the terminal device 140.

Also, the border routers 121a, 121b, 131a, and 131b may mark a (DSCP) according to the Service Level Specification (SLS). The Internet service provider networks 120 and 130 include inner routers 122a, 122b, 132a, and 132b, as well as the border routers 121a, 121b, 131a, and 131b, therein. The inner routers 122a, 122b, 132a, and 132b decide which service is provided to a flow marked by the border routers 121a, 121b, 131a, and 131b and provide the corresponding service.

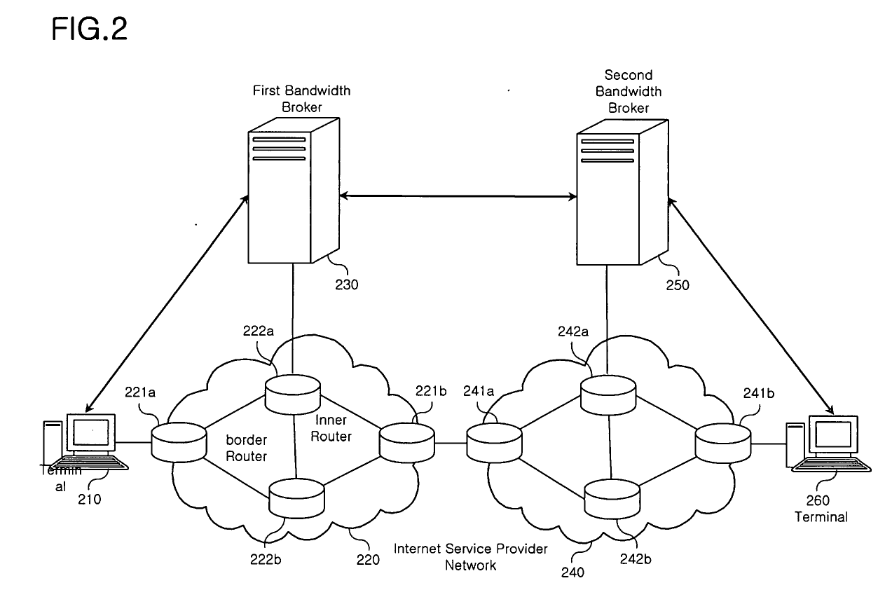

FIG. 2 is schematic diagram of a network to provide a differentiated service using a bandwidth broker according to an exemplary embodiment of the present invention.

Referring to FIG. 2, first and second bandwidth brokers 230 and 250 are added to first and second Internet service provider networks 220 and 240 (120 and 130 in FIG. 1). The first and second bandwidth brokers 230 and 250 function as resource allocation devices.

In detail, when the first and second user terminal devices 210 and 260 request a specified service, the bandwidth brokers 230 and 250 determine whether the particular service agrees with a service level agreement, where the service level agreement is a service contract negotiated previously between a user and a service provider. When the service agree with the service level agreement, the bandwidth brokers 230 and 250 allocate a policy for providing the service to border routers 221a, 221b, 241a, and 241b.

When the first bandwidth broker 230 manages one domain, thereby needing another domain to support the requested service, the adjacent second bandwidth broker 250 provides the requested service according to the service level agreement. Likewise, when the second bandwidth broker 250 manages one domain, thereby needing another domain to support the requested service, the adjacent first bandwidth broker 230 provides the requested service according to the service level agreement.

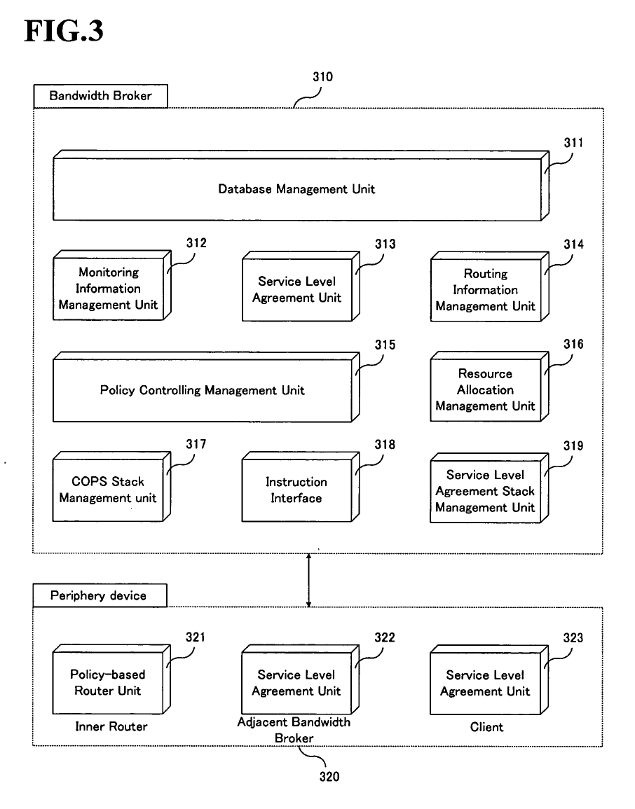

FIG. 3 is a schematic diagram of a bandwidth broker according to an exemplary embodiment of the present invention.

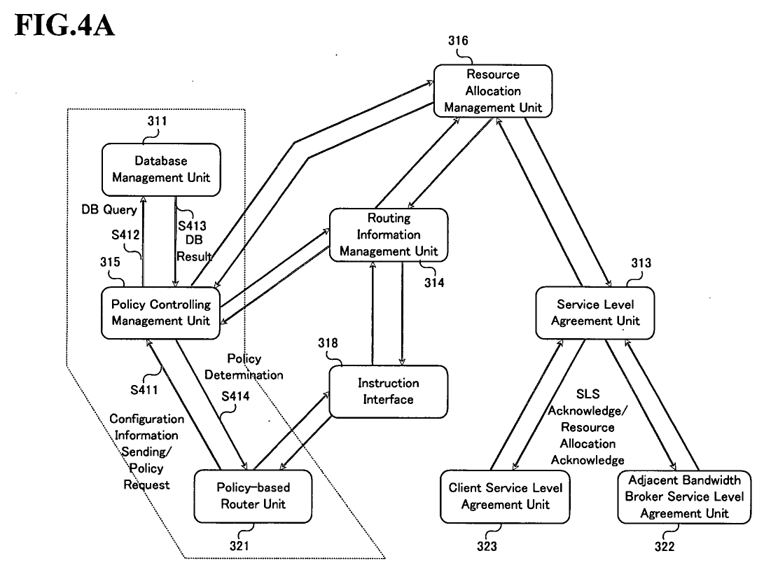

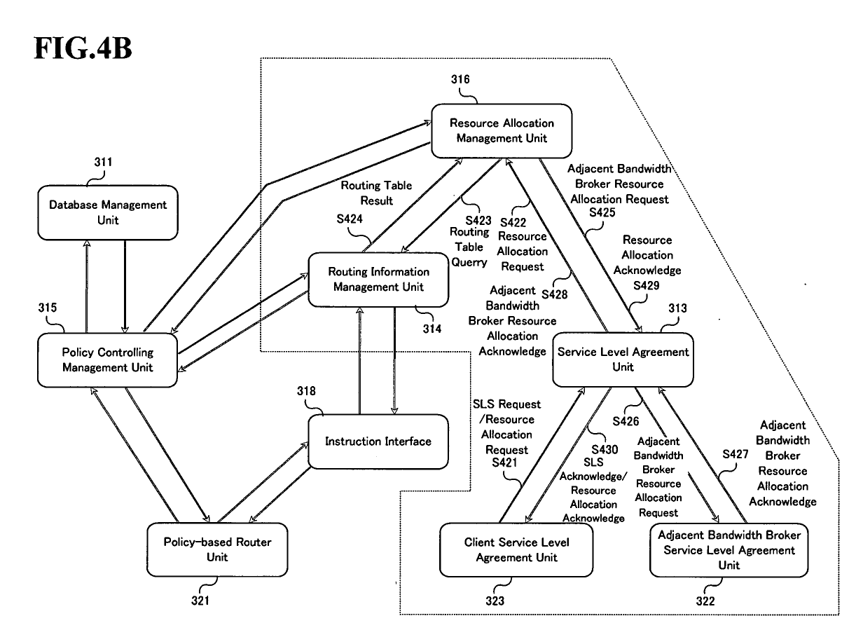

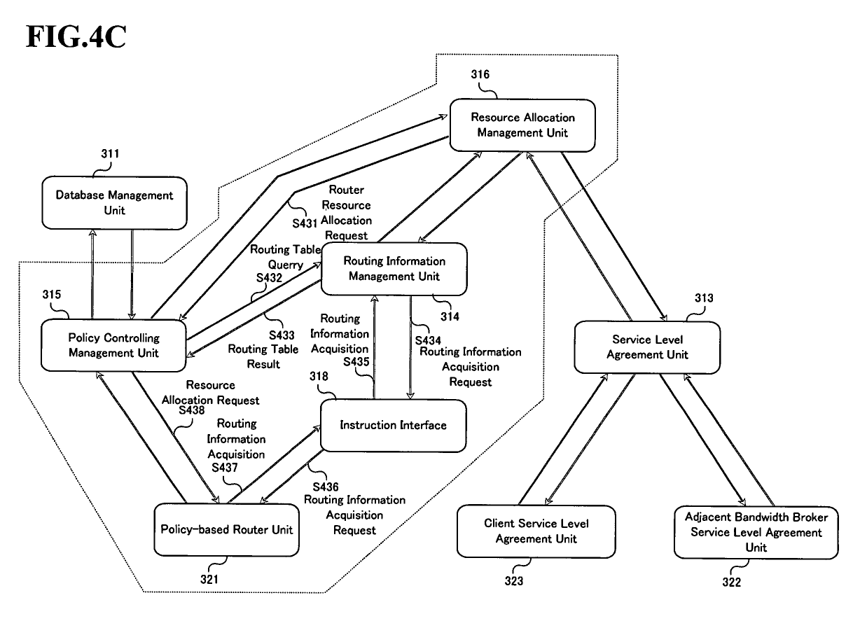

Referring to FIG. 3, a bandwidth broker 310, according to an exemplary embodiment of the present invention, includes a data base management unit 311, a monitoring information management unit 312, a service level agreement unit 313, a routing information management unit 314, a policy controlling management unit 315, a resource allocation management unit 316, a common open policy service (COPS) stack management unit 317, an instruction interface 318, and a service level agreement stack management unit 319. Also, a periphery device 320 includes a secondary policy-based router unit 321, a service level agreement unit 322 of the adjacent bandwidth broker, and a service level agreement unit 323 of a client, which is linked to the first bandwidth broker 310. Elements of the bandwidth broker 310 and a connection relation thereof with the peripheral device 320 according to an exemplary embodiment of the present invention shown in FIG. 3 are described later referring to FIG. 4A through FIG. 4C.

The database management unit 311 manages all data requested by the bandwidth broker 310 so as to process a resource allocation request. That is, the database management unit 311 manages a bandwidth broker construction information database, a routing information database, a service information database, an admission control information database, a policy information database, and a SNMP, MIB, or PIB information database.

The database stores information concerning a user and a service for providing a differentiated service, that is, user information, service information required by the user, service level agreement information between the user and the provider, router information, and network configuring information acquired by a router, and path information configured to provide an end to end service.

The monitoring information management unit 312 processes the monitoring information provided by the router.

The service level agreement unit 313 performs a service level agreement of the bandwidth broker 310 in domain, as well as a service level agreement between bandwidth brokers in domain to domain communication. For example, the service level agreement unit 313 and the service level agreement stack management unit 319 perform the service level agreement with the user, send the received service request to the resource allocation management unit, acquire the result concerning the resource allocation request, and transmit the result to the user.

The routing information management unit 314 manages and collects routing information, which is used when the bandwidth broker 310 allocates policy in a differentiated service domain. In detail, in order to provide the differentiated service, the routing information management unit 314 collects network configuring information and stores the same in the database. For example, the routing information management unit 314 collects routing tables of the routers using SNMP, stores the collected routing tables to the database, discovers a path connecting a beginning point with an end point, and stores the discovered path to the database to be reused.

The policy control management unit 315 decides a policy using a Common Open Policy Service-Policy Provisioning (COPS-PR) interface such that the router interface uses the policy to provide the differentiated service. The policy control management unit 315 decides the policy according to whether the service request and the resource allocation request are admitted.

The resource allocation management unit 316 determines available resource information and a resource allocation possibility, and acknowledges the result when client, server, or adjacent bandwidth broker request a resource allocation. The resource allocation management unit 316 determines whether the service request is consistent with the service level agreement and whether to accept the resource allocation request by using the available resource information of the path connecting the beginning point with the end point, when the service request is received by the user.

The COPS stack management unit 317 encodes/decodes COPS or COPS-PR in order to receive data from the border routers and transmit data to the same.

The instruction interface unit 318 makes a common line interface (CLI) of the corresponding device when it does not use the COPS protocol. Through the CLI configured in this manner, the policy delivered from the bandwidth broker 310 is applicable to the router.

The service level agreement stacks management unit 319 functions in encoding and decoding the service level agreement protocol inputted from the client, the server, or the adjacent bandwidth broker.

FIG. 4A to FIG. 4C show a resource allocation processing of a bandwidth broker 310 according to an exemplary embodiment of the present invention, the bandwidth broker having the same construction as shown in FIG. 3, wherein the elements of the bandwidth broker 310 allocate a resource according to the following.

Referring to FIG. 4A, a policy request processing of the router and a policy delivery processing of the bandwidth broker 310 are shown by the steps S411 to S414.

In detail, the policy-based router unit 321 sends the construction information and the policy request to the policy control management unit 315 (S411), the policy control management unit 315 sends a DB query to the database management unit 311 (S412) and gains the desired information, that is, the DB result (S413). And then, the policy control management unit 315 sends the policy decided on, based on such information, to the policy-based router unit 321 (S414), thereby applying the policy for the real operation of the router.

Referring to FIG. 4B, a service level agreement processing and a resource allocation request processing are shown by the steps S421 to S430.

In detail, the client service level agreement unit 323 of the terminal device requests the service level agreement and the resource allocation to the service level agreement unit 313 (S421). And then, the resource allocation request is delivered to the resource allocation management unit 316 (S422).

Thereafter, the end to end path information, that is, the information of the routers provided in the path connecting the source with the destination, is required so as to decide the resource allocation possibility, and thus the resource allocation management unit 316 queries the routing table to the routing information management unit 314 (S423) and obtains the result thereof (S424).

After a path discovery processing, in the case that the destination domain is different from the departure domain, the current bandwidth broker 310 should request the resource allocation to the adjacent bandwidth broker. Accordingly, the resource allocation management unit 316 sends a resource allocation request of the adjacent bandwidth broker to the service level agreement unit 313 (S425). This is again transmitted to the bandwidth broker service level agreement unit 322 (S426) and the bandwidth broker service level agreement unit 322 acknowledges the result of the processing (S427).

Next, the service level agreement unit 313 informs the result of the resource allocation request delivered from the adjacent bandwidth broker to the resource allocation management unit 316 (S428) and the resource allocation management unit 316 decides the real resource allocation possibility using the information.

As a result, the acknowledgement for the real resource allocation possibility is delivered to the service level agreement unit 313 (S429), and successively to the client service level agreement unit 323 (S430).

Referring to FIG. 4C, a processing to request resource allocation really according to the resource allocation is shown by the steps S431 to S438.

In detail, when the bandwidth broker 310 decides to accept the resource allocation possibility, the resource allocation management unit 316 requests the resource allocation of the real router to the policy control management unit 315 (S431). To this end, the acquisition of the end to end path information is required and the routing table is queried by the routing information management unit 314 (S432), and the result thereof should be sent to the policy control management unit 315 (S433).

When no necessary path information is stored, the router information management unit 314 requests a routing information acquisition to the instruction interface 318 (S434) and obtains the routing information (S435). And then the instruction interface 318 requests the routing information to the policy-based router 321 using SNMP (S436) and obtains the necessary information (S437).

Accordingly, through the obtained routing information, the policy control management unit 315 discovers the end to end path and sends a new policy to the policy based router unit 321 (S438), and finally, the resource allocation is performed.

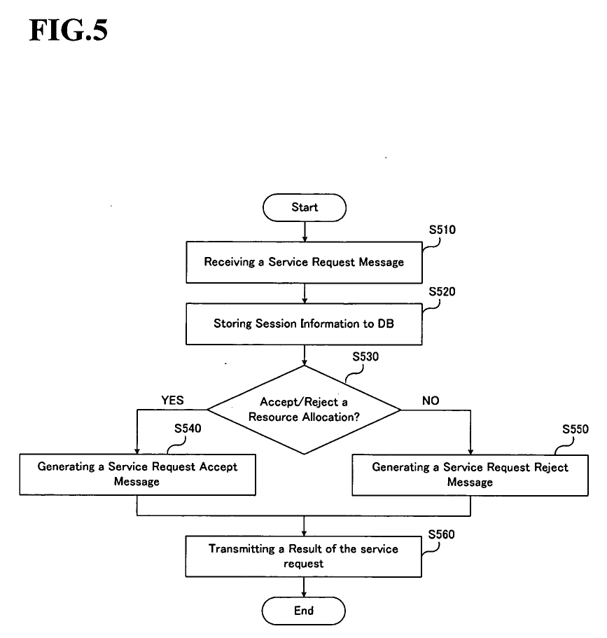

FIG. 5 is a flowchart of service level agreement processing for a resource allocation in a bandwidth broker according to an exemplary embodiment of the present invention.

Referring to FIG. 5, the bandwidth broker 310 receives messages for the service level agreement and the resource allocation request from the user (S510). The received service request message includes session information concerning the requested service, and the session information includes provider information, receiver information, and desired resource level, etc. Next, the received session information is stored in a session information database (S520), and thereafter, is used to apply the specified policy concerning the specified flow for the routers. Then, the bandwidth broker 310 receives the service request and decides to accept the current request service, that is, the resource allocation request (S530). According to an exemplary embodiment of the present invention, the bandwidth broker 310 receives the service request for the resource allocation and decides to accept the service request. This depends on the available resource status of the current network and the service level agreement negotiated between the provider and the user. When the requested service agrees with the service level agreement and the amount of available resource is larger than that of the requested resource, the resource allocation is decided to be possible and the requested service is accepted. On the other hand, when the requested service does not agree with the service level agreement and the amount of available resource is smaller than that of the requested resource, the resource allocation is decided to be rejected and the request service is rejected.

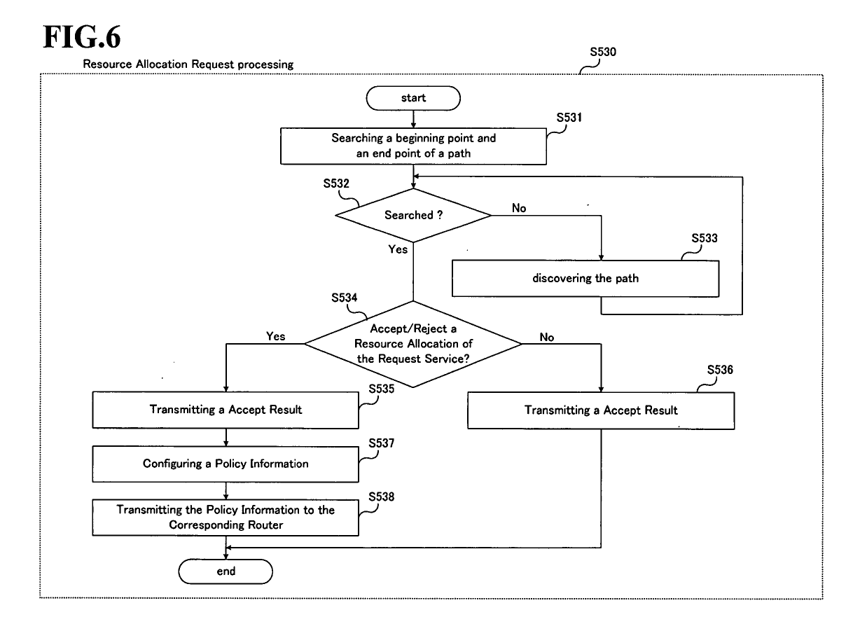

A detailed decision processing of the resource allocation request is described later with reference to FIG. 6.

Thereafter, when it is decided to accept the resource allocation, the bandwidth broker 310 generates an accept message (S540). The accept message is sent to the user terminal and the user receives the result of the service request (S560) thereby receiving the requested service according to the agreement.

When it is decided to reject the resource allocation, the bandwidth broker 310 generates a reject message (S550). The reject message is also sent to the user terminal and the user receives the result of the service request (S560) and recognizes the same so that the user requests a lower leveled service or ends the service request.

Meanwhile, FIG. 6 is a detailed flowchart for implementing a service request processing method of FIG. 5.

To implement the above-noted resource allocation request processing (S530), that is, to decide whether the resource allocation request is accepted, first, the end to end path of the terminals is discovered to be utilized for the resource allocation.

For discovering the end to end path, the prior art uses the source and destination information, but an exemplary embodiment of the present invention uses a beginning point defined by a border router of a domain including source and an end point defined by a border router of a domain including destination. The route for connecting between the beginning point and the end point is called a Path.

The beginning point and the end point are designed to store the path information and to reuse the same. At this time, terminals of a same source domain have the same beginning point, and terminals of a same destination domain have the same end point. Accordingly, when different flows have the same beginning point and the same end point, regardless of a different source value and destination value, the service is provided through the same path. Therefore, the path information can be stored using the beginning point and end point, and the stored path information can be used. Thus, the path can be quickly discovered and resource can be saved.

In detail, referring to FIG. 6, the resource allocation request processing is started by searching the beginning and end points (S531).

By the result of the searching, it is decided whether path information having the same beginning point and the same end point is stored in the path information storage device (S532), and if so, it is decided whether the path has sufficient resources to accept the resource allocation (S534).

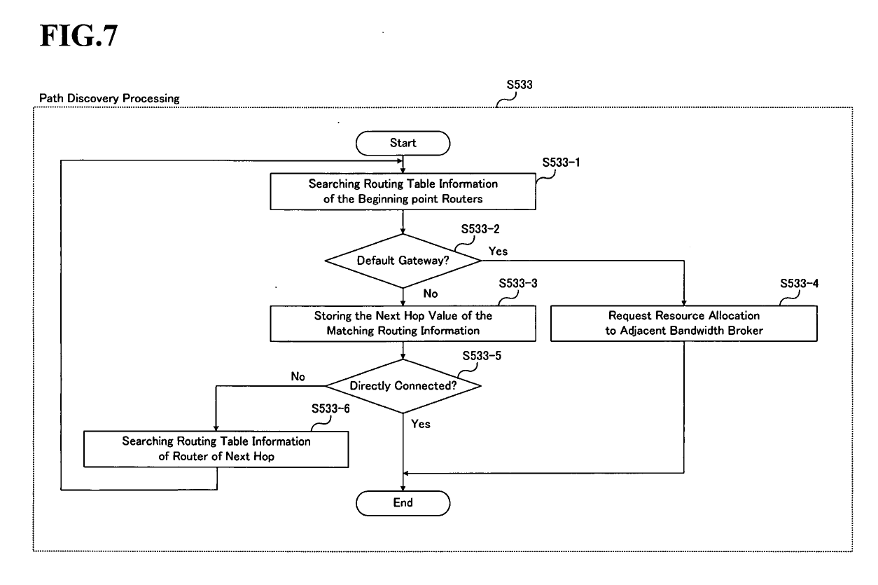

When no path information is stored in the path information storage device, a new path is discovered through the path discovery processing (S533). The new path discovery processing is described later with reference to FIG. 7.

When it is decided to accept the resource allocation, the acceptance message thereof is transmitted to the user (S535). Also, when it is decided to reject the resource allocation, the reject message thereof is acknowledged to the user (S536).

After the result of the service request acceptance is transmitted, that is, the service request is accepted, the real policy should be sent to the routers. Thus, the real policy is configured according to the service request (S537) and the policy information is transmitted to the router (S538), thereby providing the desired service.

Meanwhile, FIG. 7 is a flowchart showing path discovery processing among service request processing of the resource allocation device of FIG. 6.

As above noted referring to FIG. 6, when corresponding path information is not acquired by searching the path storage device using the beginning point and end point, the bandwidth router performs a new path discovery process (S533).

In the further path discovery processing, the routing table information of the beginning point routers is searched (S533-1). At this time, because the routing table information etc., including the beginning routers is obtained by using SNMP, the value stored in the database can be used simply.

After the routing table information is acquired, matching values are searched from the entry value of the routing table information wherein the matching value represents that the router is corresponding to a Destination Hop including the terminal of the destination (S533-2). For example, it is decided whether the matched routing information is a default gateway by inputting each entry value in a simple numerical formula (not shown).

When the matching routing information is the default gateway, meaning that the current domain does not include the destination, the adjacent bandwidth broker is requested to perform the resource allocation request (S5334).

When the matching routing information is not the default gateway, meaning that a router corresponding to the next hop of the matching routing information is on the path, the path information is stored in the database (S533-3).

Next, it is checked whether the routing information matching the formula is directly or substantially connected to the destination (S533-5). On being directly connected to the destination, as a destination Hop, the path discovery processing is finished.

When it is found that the routing information matching the formula is not directly connected, the routing table information of the router of the next Hop is searched (S533-6) and the steps S533-2 to S533-6 described above are repeated until the destination Hop is searched.

Referring to FIGS. 5 to 7, in order to discover the desired path for connecting the source with the destination in the resource allocation processing according to an exemplary embodiment of the present invention, the source and destination information itself is not used, rather the beginning point, defined as a border router of a domain including a source, and the end point, defined as a border router of a domain including a destination, are used as the representative values of the source and destination located in the same domain. Also, after the path discovery processing, the path information is stored in a database and the pre-stored path information is reused as the path information through searching.

According to an exemplary embodiment of the present invention, the pre-stored path information having the same beginning and end point can be utilized to provide the service through the same path using the beginning point, defined as a border router of a domain including a source, and the end point, defined as a border router of a domain including a destination. Also, the resource allocation can be achieved efficiently by using the path storage device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, it is determined if the service request can be supported and the result of the service request allows a resource to really allocate so that the differentiated service can be provided efficiently. Also, in the path information acquisition processing, the path information search can be quickly implemented by using a storage device so that the developed commercialization model of the differentiated service can be applied.

What is claimed is:

1. A resource allocation device using a path storage device, comprising:
a database for storing user and service information for providing a differentiated service;
a resource allocation management unit for determining whether a service request agrees with a service level agreement and whether to accept a resource allocation request using available resource information of a path connecting a beginning point with an end point, on receiving the service request of a user;
a service level agreement unit for negotiating the service level agreement with the user before receiving the service request, sending the received service request to the resource allocation management unit, acquiring the result of the resource allocation request and transmitting the result of the resource allocation request to the user;
a routing information management unit for obtaining network configuring information, storing the network configuring information in the database, discovering the path to provide the service, and storing the discovered path in the database to be used; and
a policy control management unit for deciding a policy according to whether the service request and the resource allocation request are accepted.

2. The resource allocation device of claim 1, wherein the information stored in the database includes user information, service information requested by the user, service level agreement information negotiated with the user, router information, network configuring information acquired by routers, and path information configured to provide the service.

3. The resource allocation device of claim 1, wherein the network configuring information is routing table information of routers in a domain and is obtained using a simple network management protocol (SNMP).

4. The resource allocation device of claim 3, wherein the routing table information is utilized to discover the path by the routing information management unit and the information is stored in the database.

5. The resource allocation device of claim 1, wherein the routing information management unit discovers the beginning point and the end point based on source information and destination information, and uses these two points in a path discovery processing,
wherein the beginning point is defined as a border router of a domain having the source and the end point is defined as a border router of a domain having the destination.

6. The resource allocation device of claim 5, wherein the routing information management unit searches stored path information using the beginning point and end point, and on acquiring matching information, uses the stored path information to provide the service.

7. The resource allocation device of claim 5, wherein the routing information management unit searches stored path information using the beginning point and end point, and on not acquiring matching information, repeats the path discovery processing to discover a new path.

8. The resource allocation device of claim 7, wherein the routing information management unit determines whether the path satisfies a condition for searching a destination hop until the matching information is discovered in the routing table information of the routers of the beginning point.

9. The resource allocation device of claim 8, wherein when the condition for searching a destination hop is satisfied and the corresponding routing information is given as a default gateway, an adjacent bandwidth broker is requested to allocate a resource.

10. The resource allocation device of claim 8, wherein the path discovery processing is finished when the condition for searching a destination hop is satisfied and the corresponding routing information is given as a directly connected value.

11. The resource allocation device of claim 1, wherein the resource allocation management unit determines to accept/reject the resource allocation request according to whether the user agrees with the service level agreement on performing an operation for the resource allocation.

12. The resource allocation device of claim 1, wherein the resource allocation management unit determines whether to accept the resource requested by the user and whether an available resource is found from all resources on the path, on performing an operation for the resource allocation.

13. The resource allocation device of claim 1, further comprising border routers and a common open policy service (COPS) stack management unit for sending/receiving data.

14. A resource allocation method for providing differentiated service comprising:
receiving a service request from a user;
determining whether a resource can be allocated to provide the requested service;
obtaining routing information from routers composing a differentiated service;
searching, discovering, and storing path information using the obtained routing information;
transmitting a determined policy to real routers; and
allocating the resource according to the determined policy.

15. The resource allocation method of claim 14, wherein on obtaining routing information from routers composing a differentiated service, the routing information is routing table information of routers in domain and is obtained by a Simple Network Management Protocol (SNMP).

16. The resource allocation method of claim 14, wherein the searching, discovering, and storing a path information step includes:
searching a beginning point and a end point of a path;
determining whether a path having the same beginning point and end point to be stored;
on not acquiring matching information, repeating the path discovery processing; and
on acquiring matching information, determining whether accept/reject the resource allocation according to requested service.

17. The resource allocation method of claim 16, wherein on determining whether a path having the same beginning point and end point to be stored, the beginning point and end point are searched using source information and destination information based routing information, and the path information thereof is stored in the database,
wherein the beginning point is defined as border routers of a domain having the source and the end point is defined as border routers of a domain having the destination.

18. The resource allocation method of claim 16, wherein on not acquiring matching information, repeating the path discovery processing, it is checked whether the path satisfies a condition for searching a destination Hop until the matching information is discovered in the routing table information of the routers of the beginning point.

19. The resource allocation method of claim 18, wherein on not acquiring matching information, an adjacent bandwidth broker is requested to allocate a resource repeating the path discovery processing, when the conditions for searching destination Hop is satisfied and the corresponding routing information is given as a default gateway.

20. The resource allocation method of claim 18, wherein on not acquiring matching information, repeating the path discovery processing, the path discovery processing is finished when the conditions for searching a destination hop is satisfied and the corresponding routing information is given as a value directly connected to the destination.
